(19) United States
(12) Patent Application Publication
(10) Pub. No.: US 2023/0286416 A1
(43) Pub. Date: Sep. 14, 2023

(54) METHOD AND DEVICE FOR DETERMINING VEHICLE CHARGING INTENTION AND VEHICLE

(71) Applicant: Beijing CHJ Information Technology Co., Ltd., Beijing (CN)

(72) Inventor: Wei ZHANG, Beijing (CN)

(21) Appl. No.: 18/322,068

(22) Filed: May 23, 2023

Related U.S. Application Data
(63) Continuation of application No. PCT/CN2021/132492, filed on Nov. 23, 2021.

(30) Foreign Application Priority Data
Nov. 24, 2020 (CN) 202011334649.9

(51) Int. Cl. B60L 58/24; B60L 53/62; G06F 17/18

(52) U.S. Cl. CPC B60L 58/24; B60L 53/62; G06F 17/18

(57) ABSTRACT

A method for determining a vehicle charging intention includes: acquiring travel information of a target travel as target travel information; determining a confidence level of a charging intention in the target travel according to the target travel information, in which the confidence level of the charging intention is determined by a charging probability of at least one preset dimension, in which the preset dimension includes a charging position dimension, a charging time dimension and a battery state dimension; and determining whether the charging intention exists in the target travel according to the confidence level of the charging intention.

### CROSS-REFERENCE TO RELATED APPLICATIONS

This application is a continuation of International Application No. PCT/CN2021/132492, filed Nov. 23, 2021, which claims priority to Chinese Patent Application Serial No. 202011334649.9, filed Nov. 24, 2020, the entire disclosures of which are incorporated herein by reference.

### FIELD

The present disclosure relates to a field of vehicles, and more particularly to a method and a device for determining a vehicle charging intention, and a vehicle.

### BACKGROUND

At present, in order to improve a charging effect of a vehicle, an intention of charging usually needs to be predicted to a certain extent, to allow the vehicle to prepare for charging in advance. In related technologies, the charging intention is generally determined by a surrounding environment of the vehicle, or the charging of the vehicle is guided and planned with regards to aspects of distance and time costs for charging, and a device utilization of a charging station. However, drivers' charging habits are not considered in the related art, and it is difficult to accurately determine an actual charging intention of the driver.

### SUMMARY

An object of the present disclosure is to provide a method and a device for determining a vehicle charging intention, and a vehicle.

In order to achieve the above-mentioned object, in a first aspect of the present disclosure, a method for determining a vehicle charging intention is provided. The method includes: acquiring travel information of a target travel as target travel information; determining a confidence level of a charging intention in the target travel according to the target travel information, in which the confidence level of the charging intention is determined by a charging probability of at least one preset dimension, in which the preset dimension includes a charging position dimension, a charging time dimension and a battery state dimension; and determining whether the charging intention of the user exists in the target travel according to the confidence level of the charging intention.

In a second aspect of the present disclosure, a device for determining a vehicle charging intention is provided. The device includes: a processor; a memory having stored therein a computer program that, when executed by the processor, causes the processor to perform the method as described in the first aspect.

In a third aspect of the present disclosure, a vehicle for performing the method as described in the first aspect is provided.

Additional aspects and advantages of embodiments of present disclosure will be described in detail in the following descriptions.

### BRIEF DESCRIPTION OF THE DRAWINGS

The drawings are used to provide a further understanding of the present disclosure, and constitutes a part of the description. The present disclosure will become apparent and more readily appreciated from the following descriptions made with reference to the drawings which do not limit the present disclosure, in which:

FIG. 1 is a flow chart of a method for determining a vehicle charging intention according to an embodiment of the present disclosure.

FIG. 2 is a flow chart of an operation of determining a confidence level of a charging intention in the target travel according to target travel information in a method for determining a vehicle charging intention according to an embodiment of the present disclosure.

FIG. 3 is a flow chart of a method for determining a vehicle charging intention according to an embodiment of the present disclosure.

FIG. 4 is a flow chart of a method for determining a vehicle charging intention according to an embodiment of the present disclosure.

FIG. 5 is a schematic diagram of a system applying a method for determining a vehicle charging intention according to an embodiment of the present disclosure.

FIG. 6 is a block diagram of a device for determining a vehicle charging intention according to an embodiment of the present disclosure.

### DETAILED DESCRIPTION

Embodiments of the present disclosure are described in detail with reference to the drawings. It should be noted that the embodiments described herein with reference to drawings are explanatory, and used to generally understand the present disclosure. The embodiments shall not be construed to limit the present disclosure.

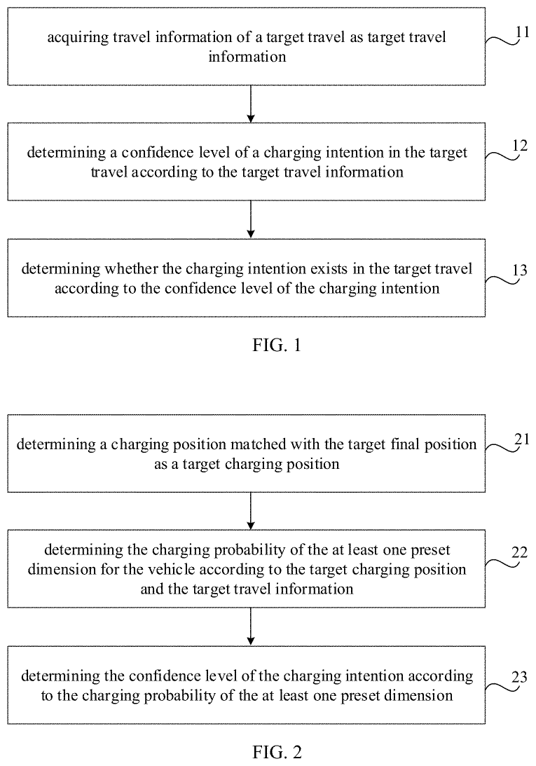

FIG. 1 is a flow chart of a method for determining a vehicle charging intention according to an embodiment of the present disclosure. The method provided by the present disclosure can be applied in a vehicle, and can also be applied in a server or a cloud capable of communicating with the vehicle. As shown in FIG. 1, the method may include the following operations.

In block 11, travel information of a target travel is acquired as target travel information.

In block 12, a confidence level of a charging intention in the target travel is determined according to the target travel information.

In block 13, it is determined whether the user has the charging intention in the target travel according to the confidence level of the charging intention.

The confidence level of the charging intention is determined by a charging probability of at least one preset dimension. The preset dimension includes a charging position dimension, a charging time dimension and a battery state dimension.

In an embodiment of the present disclosure, the travel information may include, but is not limited to, at least one selected from a starting position, a final position, a starting time and an ending time of the travel, a state of charge (SOC) value of a vehicle battery at the beginning of the travel, and a driving route of the travel.

The starting position of the travel refers to a position where the vehicle is located at the beginning of the travel. The final position for the vehicle refers to a position where the vehicle is located at the end of the travel. The starting time of the travel refers to a time when the travel starts.

The ending time of the travel refers to a time when the travel ends. The SOC value of the vehicle battery at the beginning of the travel refers to a SOC value corresponding to a power battery of the vehicle at the beginning of the travel. The driving route of the travel refers to a driving trajectory of the vehicle during the driving process corresponding to the travel. In an embodiment, vehicle positions are acquired periodically. The vehicle positions acquired in the travel are ranked in a sequence of the time when each the position is acquired, and they constitute the trajectory, i.e., the driving route of the vehicle in this travel.

Accordingly, based on the definition of the travel information described above, the target travel information includes a target starting position, a target final position, a target starting time point and a target ending time, a target SOC value, and a target driving route.

In an optional embodiment, the target travel is determined by acquiring vehicle position information; acquiring historical travel information of the vehicle; generating a predicted travel according to the historical travel information and the vehicle position information; and determining the target travel according to the predicted travel.

In this embodiment, a future travel is predicted or determined from the historical travel records or habits of the user, and the target travel is determined according to the predicted travel.

The vehicle position information refers to a position where the vehicle is currently located.

The historical travel information of the vehicle may indicate the user's historical driving habits. Therefore, the historical travel information is beneficial to improve the accuracy of the travel prediction. Accordingly, in the initial stage, it is necessary to collect the relevant data of the vehicle in the historical driving processes, to form the historical travel information. That is, the historical travel information is based on the big data. Since the present disclosure focuses on the prediction of vehicle charging intention, data to be collected is substantially the data related to the vehicle charging. For example, data of daily driving charging of the user is recorded, which may include a starting time when the charging travel starts, a starting time when the charging begins, a charging position, an SOC value of a battery at the beginning of the travel (or at the beginning of the charging), a charging duration.

Based on the big data (i.e., the collected relevant data), statistical analysis is performed according to certain rules to acquire the historical travel information. The historical travel information may represent the user's charging habits to a certain extent. For example, the collected data may be statistically analyzed in the following manners to facilitate subsequent data processing.

All travels in which the vehicle is charged at the final position are recorded, and the starting positions and the final positions of the travels are recorded. Such travels are defined as a charging travel (historical charging travel), and the final positions of the travels are defined as a charging position (i.e., a location where the charging operation is performed).

The number of travels for each charging position in which the charging position is the final position of the travels is recorded. For example, among all historical travels recorded, there are 5 travels having a final position being charging position A, and there are 10 travels having a final position being charging position B.

The number of times the vehicle is charged at each charging position is recorded. For example, among all historical travels recorded, the vehicle has been charged at charging position C for 15 times.

For each charging position the vehicle is driving to, SOC states (which may be represented by SOC values) of the power battery at the beginning of the historical charging travels are recorded. In addition, different SOC ranges may be determined according to the SOC value, and the number of occurrences of each SOC range is recorded.

For each charging position the vehicle is driving to, starting time points of the historical charging travels are recorded. In addition, different charging starting time intervals may be determined according to the starting time point, and the number of occurrences of each charging starting time interval is recorded.

Based on the above, the historical travel information may accordingly include historical starting time point, historical initial SOC value and historical charging position of every historical charging travel, and further include the number of travels for every charging position in which the charging position is the final position of the travels, and the number of times the vehicle is charged at every historical charging position.

Based on the above, the predicted travel may be generated according to the historical travel information and the vehicle position information.

In an embodiment, an occurrence frequency of a designated starting position to a designated final position within a certain time period is identified according to the historical travel information, and a travel corresponding to the combination of <starting position, final position> with the highest occurrence frequency is used as the predicted travel for the time period/section.

In a further embodiment, according to the vehicle position information, a starting position in the historical travel information that matches the vehicle position information (for example, a distance between the starting position and the vehicle position is less than a distance threshold) may be determined, and from the historical charging travels corresponding to the starting position, a historical charging travel with the highest occurrence frequency in a time period/section of a travel to be predicted is selected, and this historical charging travel having a corresponding<starting position, final position> is regarded as the predicted travel.

In a further embodiment, according to historical travel information, the user's travel habits within a designated time period may be acquired from statistical analysis. For example, on workday from 8:00 to 9:00, the user drives from position A to position B, and from 18:00 to 19:00, the user drives from position B to position A. The predicted travel on the workday can be generated from these data, and starting position, final position and time period of the travel may refer to the travel habits acquired from the statistical analysis.

After acquiring the predicted travel, the target travel is determined according to the predicted travel.

In an embodiment, the predicted travel is directly used as the target travel.

In a further embodiment, determining the target travel according to the predicted travel includes: outputting predicted travel information for characterizing the predicted travel; and determining the predicted travel as the target travel when a confirmation instruction for the predicted travel information is received from the user.

In this embodiment, after the predicted travel is generated, it will be pushed to the user for confirmation, and the travel will be regarded as a valid travel, that is, the target travel, only when the confirmation of the user is received.

The predicted travel information may include a starting position, a final position, and a starting time point of the travel.

In an embodiment, the predicted travel information is delivered in a form of a schedule reminder to an APP of a terminal of the user, and the user may confirm whether the user has a current travel plan. If the user confirms the travel, the vehicle may determine data of the predicted travel as valid data which may be used as a basis for subsequent data processing, for example, for subsequent identification of the confidence level of the charging intention during the target travel. If the user refuses to accept the travel, the data related to the predicted travel will be deleted.

In an optional embodiment, the user may set the target travel. In this embodiment, the target travel is determined by: receiving a setting instruction for the target travel from the user; and determining a travel indicated by the setting instruction as the target travel. The setting instruction is used to indicate the travel information of the target travel.

In an embodiment, the user may preset a plurality of travel plans. The travel planner may be set with a repeat time, and a starting time and an ending time for a reminder.

The operation in block 12 is described in detail below.

In an optional embodiment, the operation in block 12 may include the following operations as shown in FIG. 2.

In block 21, a charging position matched with the target final position is determined as a target charging position.

The charging position is a position where a vehicle is charged in a historical charging travel, and the historical charging travel is a travel in which the vehicle is charged. Relevant definitions are described as above, and are not elaborated here again.

In block 22, the charging probability of the at least one preset dimension for the vehicle is determined according to the target charging position and the target travel information.

As described above, the confidence level of the charging intention is determined by the charging probability of the at least one preset dimension, and the preset dimension includes a charging position dimension, a charging time dimension and a battery state dimension.

In an optional embodiment, when the preset dimension includes the charging position dimension, a charging probability of the charging position dimension for the vehicle is acquired by: determining a probability of the vehicle being charged at the target charging position as a first probability; determining a probability of the target final position being the charging position as a second probability; and determining the charging probability of the charging position dimension for the vehicle according to a product of the first probability and the second probability.

In an embodiment, the operation of determining the probability of the vehicle being charged at the target charging position as the first probability includes: acquiring a first number of times the vehicle is charged at the target charging position in the historical charging travels and the number of matching travels where the target charging position is the final position in the historical charging travels; and determining the first probability according to a ratio of the first number of times to the number of the matching travels.

In an embodiment, the ratio of the first number of times to the number of the matching travels is regarded as the first probability. In another embodiment, after the ratio of the first number of times to the number of the matching travels is acquired, the ratio is subjected to a preset calculation (e.g., multiplied by a preset coefficient), and a result is acquired as the first probability.

In an embodiment, the operation of determining the probability of the target final position being the charging position as the second probability includes: determining a similarity between the target driving route and a driving route of a designated charging travel; and determining the second probability according to the similarity corresponding to each designated charging travel.

The designated charging travel is a historical charging travel of which a travel starting position matches the target starting position. The term “match” here may refer to that the starting position of the historical charging travel is the target starting position, or a distance between the starting position of the historical charging travel and the target starting position is less than a preset threshold, or the starting position of the historical charging travel and the target starting position belong to the same region which may be preset.

According to the target driving route and the driving route corresponding to the designated charging travel (acquired from e.g., the big data as described above), the similarity between the target driving route and each designated charging travel is determined. Meanwhile, for each designated charging travel, there is a probability of the travel final position being the charging position. In one embodiment, the above-mentioned probability corresponding to the designated charging travel which corresponds to the maximum similarity may be used as the second probability.

After the first probability and the second probability are acquired, the charging probability of the charging position dimension for the vehicle is determined according to the product of the first probability and the second probability.

In an embodiment, the product of the first probability and the second probability is regarded as the charging probability of the charging position dimension for the vehicle. In another embodiment, after the product of the first probability and the second probability is acquired, the product is subjected to a preset calculation (e.g., multiplied by a preset coefficient), and a result is acquired as the charging probability of the charging position dimension for the vehicle.

After the operations described above, the charging probability of the charging position dimension for the vehicle can represent a probability that the vehicle is charged at a possible charging position of the target travel, which can reflect the charging intention of the user in an aspect of the charging position.

In an optional embodiment, when the preset dimension includes the charging time dimension, a charging probability of the charging time dimension is acquired by: determining a charging starting time interval, in which the target starting time point is located, as a target time interval; acquiring a second number of times the vehicle is charged in the target time interval in the historical charging travels and a first number of times the vehicle is charged at the target charging position in the historical charging travels; and determining the charging probability of the charging time dimension for the vehicle according to a ratio of the second number of times to the first number of times.

The charging starting time interval is preset according to a starting time point of every historical charging travel. As described above, different time intervals may be determined according to the starting time points recorded statistically, and are regarded as different charging starting time intervals.

In an embodiment, the ratio of the second number of times to the first number of times is regarded as the charging probability of the charging time dimension for the vehicle. In another embodiment, after the ratio of the second number of times to the first number of times is acquired, the ratio is subjected to a preset calculation (e.g., multiplied by a preset coefficient), and a result is acquired as the charging probability of the charging time dimension for the vehicle.

After the operations described above, the charging probability of the charging time dimension for the vehicle can represent a probability that the vehicle is charged in such a travel that the starting time of the travel is the target starting time, which can reflect the charging intention of the user in an aspect of the charging time.

In an optional embodiment, when the preset dimension includes the battery state dimension, a charging probability of the battery state dimension for the vehicle is acquired by: determining an SOC range, in which a target initial SOC value is located, as the target SOC range; acquiring a third number of times the vehicle is charged in the target SOC range in the historical charging travels and a first number of times the vehicle is charged at the target charging position in the historical charging travels; and determining the charging probability of the battery state dimension for the vehicle according to a ratio of the third number of times to the first number of times.

The SOC range is preset according to an initial SOC value of every historical charging travel. As described above, different SOC ranges may be determined according to the initial SOC values recorded statistically.

In an embodiment, the ratio of the third number of times to the first number of times is regarded as the charging probability of the battery state dimension for the vehicle. In another embodiment, after the ratio of the third number of times to the first number of times is acquired, the ratio is subjected to a preset calculation (e.g., multiplied by a preset coefficient), and a result is acquired as the charging probability of the battery state dimension for the vehicle.

After the operations described above, the charging probability of the battery state dimension for the vehicle can represent a probability that the vehicle is charged in such a travel that the travel starts with the target initial SOC value, which can reflect the charging intention of the user in an aspect of the battery state.

Further, in block 23, the confidence level of the charging intention is determined according to the charging probability of the at least one preset dimension.

After the charging probability of every preset dimension is acquired, the confidence level of the charging intention is determined.

In an optional embodiment, operation in block 23 may include: determining the confidence level of the charging intention according to a product of the charging probability of the at least one preset dimension.

In an embodiment, the product of the charging probability of every preset dimension is regarded as the confidence level of the charging intention. In another embodiment, after the product of the charging probability of every preset dimension is acquired, the product is subjected to a preset calculation (e.g., multiplied by a preset coefficient), and a result is acquired as the confidence level of the charging intention.

In this way, the charging intention can be determined with regard to various dimensions, thus improving the accuracy of the determination of the charging intention. Moreover, the more preset dimensions are, the more accurate the determination of the charging intention is.

The operation of determining whether the user has the charging intention in the target travel according to the confidence level of the charging intention in block 13 as shown in FIG. 1 includes: determining that the user has the charging intention in the target travel when the confidence level of the charging intention is greater than or equal to a confidence threshold; and determining that the user has no charging intention in the target travel when the confidence level of the charging intention is less than the confidence threshold. The confidence threshold may be preset in practice.

With the technical solution described above, the travel information of the target travel with the charging intention to be determined is acquired as the target travel information, the confidence level of the charging intention of the user in the target travel is determined according to the target travel information, and it is determined whether the user has the charging intention in the target travel according to the confidence level of the charging intention. The confidence level of the charging intention is determined by the charging probability of the at least one preset dimension. The preset dimension includes the charging position dimension, the charging time dimension and the battery state dimension. In this way, the confidence level of the charging intention is determined on the basis of the user's habits with regard to dimensions of the charging position, the charging time and the battery state, and then it is determined whether the user has the charging intention according to the confidence level. This can effectively improve the accuracy of the determination of the charging intention, provide a reliable basis for battery thermal management, and improve the charging effect for the vehicle.

In an embodiment, before the operation in block 12, the method provided in the present disclosure may further includes: determining that the target travel information satisfies a preset condition.

That is, after acquiring the target travel information, it is determined whether the target travel information meets one or more preset conditions. If it is determined that the target travel information satisfies the preset condition, the confidence level of the charging intention during the corresponding target travel will be calculated. If it is determined that the target travel information does not satisfy the preset condition, it directly indicates that the user does not have a charging intention during the target travel, and thus the subsequent operations can be omitted.

The preset condition includes at least one of conditions as follows: among preset charging positions, at least one charging position is within a preset distance away from the target final position; among preset charging starting time intervals, a charging starting time interval including the target starting time point exists; and among preset SOC ranges, an SOC range including the target initial SOC value exists.

The final position of the target travel should be close to an existing charging point. That is, if there is no charging position within the preset distance away from the target final position, it can be determined there is a lack of the charging intention for the vehicle because the charging point is far away. Accordingly, there is no need to make subsequent confidence level determination, and data processing work can be saved. Further, the determinations based on the charging starting time interval and the SOC range are performed in the same way as described above, and will not be elaborated here again.

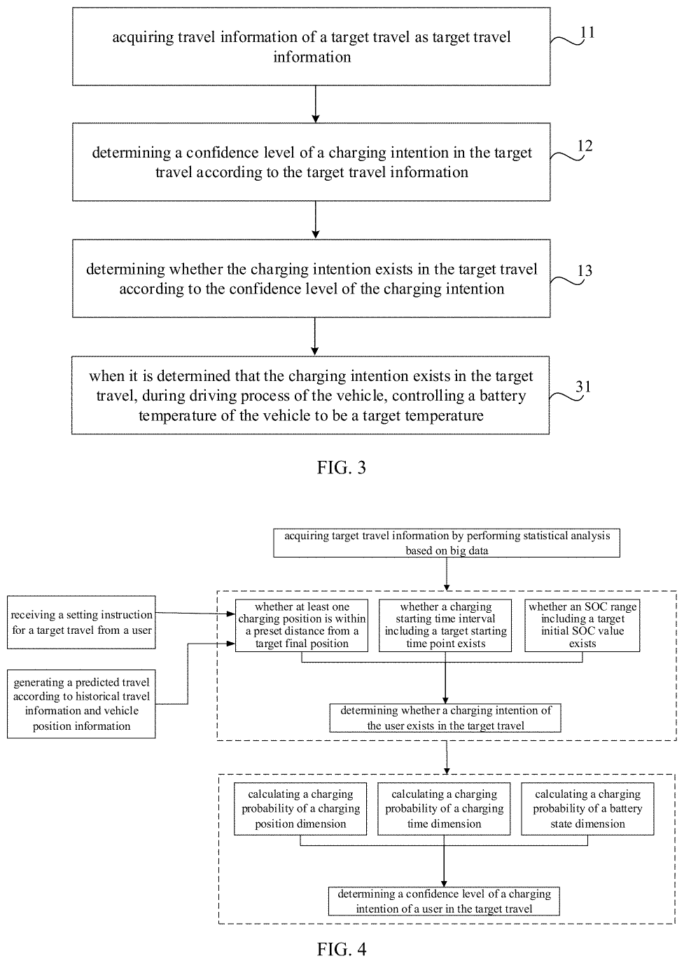

In an embodiment, as shown in FIG. 3, besides the operations described in FIG. 1, the method provided by the present disclosure may further include the following operation.

In block 31, when it is determined that the user has the charging intention in the target travel, a battery temperature of the vehicle is controlled to be a target temperature during driving process of the vehicle. The target temperature is a temperature suitable for charging a vehicle battery.

In one embodiment, the battery temperature of the vehicle may be controlled to be the target temperature during a preset time period before the vehicle reaches the target charging position.

Based on the above operations, when it is determined that the vehicle has the charging intention in the target travel, the temperature of the battery can be controlled in advance to reach the temperature that is favorable for charging the battery, thus realizing a better charging for the battery.

In an optional embodiment, FIG. 4 shows a flow chart of a method provided in the present disclosure. The specific implementation manners of the operations may refer to the details as described above, and are not elaborated here again.

With the technical solution described above, the travel information of the target travel with the charging intention to be determined is acquired as the target travel information, the confidence level of the charging intention of the user in the target travel is determined according to the target travel information, and it is determined whether the user has the charging intention in the target travel according to the confidence level of the charging intention. The confidence level of the charging intention is determined by the charging probability of the at least one preset dimension. The preset dimension includes the charging position dimension, the charging time dimension and the battery state dimension. In this way, the confidence level of the charging intention is determined on the basis of the user's habits with regard to dimensions of the charging position, the charging time and the battery state, and then it is determined whether the user has the charging intention according to the confidence level. This can effectively improve the accuracy of the determination of the charging intention, provide a reliable basis for battery thermal management, and improve the charging effect for the vehicle.

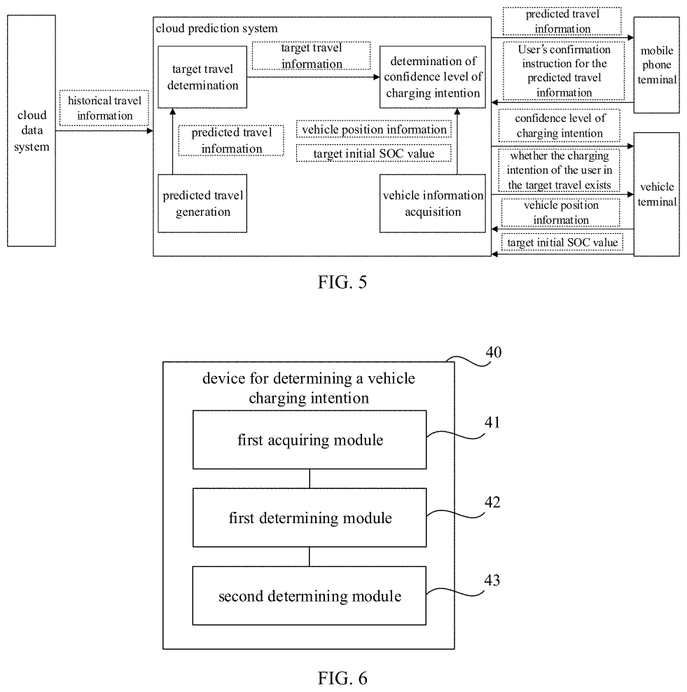

In an optional embodiment, the method provided by the present disclosure can be performed by a cloud server, the cloud server can be provided with a cloud data system and a cloud prediction system, and the cloud server can communicate with the user's mobile phone and the vehicle. FIG. 5 shows a schematic diagram of the above-described structure. In FIG. 5, a direction of an arrow may indicate a direction of information transmission, and contents disclosed in blocks near the arrows refer to the transmitted information.

The cloud data system is configured to collect data and process data. For example, as referred to the above-mentioned operations, data related to the vehicle in the historical travels is collected to form the historical travel information. The cloud data system can collect the above data and perform statistical analysis on the data to obtain the historical travel information. Further, as shown in FIG. 5, the cloud data system will synchronize the historical travel information to the cloud prediction system.

The cloud prediction system is a main body for implementing the method for determining the vehicle charging intention provided by the present disclosure, which includes four functional modules, i.e., a module configured to generate a predicted travel (referred as M1 hereafter), a module configured to determine a target travel (referred as M2 hereafter), a module configured to determine a confidence level of a charging intention (referred as M3 hereafter), and a module configured to acquire vehicle information (referred as M4 hereafter). M1-M4 may determine the charging intention of the user in the target travel in the following manner:

M1 generates a predicted travel according to historical travel information;

M1 sends predicted travel information of the predicted travel to M2, and sends the predicted travel information to a mobile terminal of a user, to let the user to confirm whether to accept this travel;

After M2 receives a confirmation instruction for the predicted travel information from the user, M2 determines a target travel according to the predicted travel information, and acquires target travel information;

M2 sends the target travel information to M3;

M3 determines a confidence level of a charging intention of the user in the target travel according to the target travel information and parameters acquired from M4, to determine whether the user has the charging intention in the target travel, and sends a determination result to a vehicle terminal; and

M4 acquires the related parameters via the vehicle terminal, the parameters are required in the data processing operation of M3.

It should be noted that the specific manner in which each element in the above-mentioned system performs the operation has been described in detail in the method embodiments as described above, and will not be elaborated here again.

FIG. 6 is a block diagram of a device for determining a vehicle charging intention according to an embodiment of the present disclosure. As shown in FIG. 6, the device 40 includes a first acquiring module 41, a first determining module 42 and a second determining module 43.

The first acquiring module 41 is configured to acquire travel information of a target travel as target travel information. The first determining module 42 configured to determine a confidence level of a charging intention in the target travel according to the target travel information. The confidence level of the charging intention is determined by a charging probability of at least one preset dimension. The preset dimension includes a charging position dimension, a charging time dimension and a battery state dimension. The second determining module 43 is configured to determine whether the user has the charging intention in the target travel according to the confidence level of the charging intention.

In an embodiment, the target travel information includes a target final position of the target travel. The first determining module 42 includes: a first determining sub-module configured to determine a charging position matched with the target final position as a target charging position, in which the charging position is a position where a vehicle is charged in a historical charging travel, and the historical charging travel is a travel in which the vehicle is charged; a second determining sub-module configured to determine the charging probability of the at least one preset dimension for the vehicle according to the target charging position and the target travel information; and a third determining sub-module configured to determine the confidence level of the charging intention according to the charging probability of the at least one preset dimension.

In an embodiment, the target travel information further includes a target starting position and a target driving route of the target travel. When the preset dimension includes the charging position dimension, a charging probability of the charging position dimension for the vehicle is acquired by the following modules: a fourth determining sub-module configured to determine a probability of the vehicle being charged at the target charging position as a first probability; a fifth determining sub-module configured to determine a probability of the target final position being the charging position as a second probability; and a sixth determining sub-module configured to determine the charging probability of the charging position dimension for the vehicle according to a product of the first probability and the second probability.

In an embodiment, the fourth determining sub-module configured to: acquire a first number of times the vehicle is charged at the target charging position in the historical charging travels and the number of matching travels where the target charging position is the final position in the historical charging travels; and determine the first probability according to a ratio of the first number of times to the number of the matching travels.

In an embodiment, the fifth determining sub-module configured to: determine a similarity between the target driving route and a driving route of a designated charging travel, in which the designated charging travel is a historical charging travel of which a travel starting position matches the target starting position; and determine the second probability according to the similarity corresponding to each designated charging travel.

In an embodiment, the target travel information further includes a target starting time point of the target travel. When the preset dimension includes the charging time dimension, a charging probability of the charging time dimension is acquired by the following modules: a seventh determining sub-module configured to determine a charging starting time interval, in which the target starting time point is located, as a target time interval, the charging starting time interval being preset according to a starting time point of every historical charging travel; a first acquiring sub-module configured to acquire a second number of times the vehicle is charged in the target time interval in the historical charging travels and a first number of times the vehicle is charged at the target charging position in the historical charging travels; and an eighth determining sub-module configured to determine the charging probability of the charging time dimension for the vehicle according to a ratio of the second number of times to the first number of times.

In an embodiment, the target travel information further includes a target initial SOC value of a vehicle battery at the beginning of the target travel. When the preset dimension includes the battery state dimension, a charging probability of the battery state dimension for the vehicle is acquired by the following modules: a ninth determining sub-module configured to determine an SOC range, in which a target initial SOC value is located, as the target SOC range, the SOC range being preset according to an initial SOC value of every historical charging travel; a second acquiring sub-module configured to acquire a third number of times the vehicle is charged in the target SOC range in the historical charging travels and a first number of times the vehicle is charged at the target charging position in the historical charging travels; and a tenth determining sub-module configured to determine the charging probability of the battery state dimension for the vehicle according to a ratio of the third number of times to the first number of times.

In an embodiment, the third determining sub-module is configured to determine the confidence level of the charging intention according to a product of the charging probability of the at least one preset dimension.

In an embodiment, the second determining module 43 includes: an eleventh determining sub-module configured to determine that the user has the charging intention in the target travel when the confidence level of the charging intention is greater than or equal to a confidence threshold; and a twelfth determining sub-module configured to determine that the user has no charging intention in the target travel when the confidence level of the charging intention is less than the confidence threshold.

In an embodiment, the target travel information includes a target final position, a target starting time point, and a target initial SOC value of a vehicle battery at the beginning of the target travel. The first determining module is configured to determine that the target travel information satisfies a preset condition before the determination of the confidence level of the charging intention of the user in the target travel according to the target travel information. The preset condition includes at least one of conditions as follows: among preset charging positions, at least one charging position is within a preset distance away from the target final position; among preset charging starting time intervals, a charging starting time interval including the target starting time point exists; and among preset SOC ranges, an SOC range including the target initial SOC value exists.

In an embodiment, the target travel is determined by the following modules: a second acquiring module configured to acquire vehicle position information; a third acquiring module configured to acquire historical travel information of a vehicle, the historical travel information including a historical starting time point, a historical initial SOC value, and a historical charging position of every historical charging travel, and further including the number of historical travels for each historical charging position in which the historical charging position is the final position of the historical travels and the number of times the vehicle is charged at each historical charging position; a generating module configured to generate a predicted travel according to the historical travel information and the vehicle position information; and a fourth determining module configured to determine the target travel according to the predicted travel.

In an embodiment, the fourth determining module includes: an outputting sub-module configured to output predicted travel information for characterizing the predicted travel; and a thirteenth determining sub-module configured to determine the predicted travel as the target travel when a confirmation instruction for the predicted travel information is received from the user.

In an embodiment, the target travel is determined by the following modules: a receiving module configured to receive a setting instruction for the target travel from the user, the setting instruction indicating the travel information of the target travel; and a fifth determining module configured to determine a travel indicated by the setting instruction as the target travel.

In an embodiment, the device 40 further includes a temperature-controlling module. When it is determined that the user has the charging intention in the target travel, the temperature-controlling module is configured to control a battery temperature of the vehicle to be a target temperature during driving process of the vehicle. The target temperature is a temperature suitable for charging a vehicle battery.

Regarding the device in the above-mentioned embodiments, the specific manners in which each module performs corresponding operation may refer to the details described in the method embodiments, and will not be elaborated here again.

The present disclosure further provides a vehicle for performing the method of any embodiment of the present disclosure.

The present disclosure further provides a device for determining a vehicle charging intention. The device includes: a processor; a memory having stored therein a computer program that, when executed by the processor, causes the processor to perform the method in any embodiment as described above.

The present disclosure further provides a non-transitory computer-readable storage medium having stored therein instructions that, when executed by a processor of a mobile terminal, causes the mobile terminal to perform the method in any embodiment as described above.

It will be understood that, the flow chart or any process or method described herein in other manners may represent a module, segment, or portion of code that includes one or more executable instructions to implement the specified logic function(s) or that includes one or more executable instructions of the steps of the progress. Although the flow chart shows a specific order of execution, it is understood that the order of execution may differ from that which is depicted. For example, the order of execution of two or more boxes may be scrambled relative to the order shown. Also, two or more boxes shown in succession in the flow chart may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure. Also, the flow chart is relatively self-explanatory and is understood by those skilled in the art to the extent that software and/or hardware can be created by one with ordinary skill in the art to carry out the various logical functions as described herein.

The logic and operation described in the flow chart or in other manners, for example, a scheduling list of an executable instruction to implement the specified logic function(s), it can be embodied in any computer-readable medium for use by or in connection with an instruction execution system such as, for example, a processor in a computer system or other system. In this sense, the logic may include, for example, statements including instructions and declarations that can be fetched from the computer-readable medium and executed by the instruction execution system. In the context of the present disclosure, a “computer-readable medium” can be any medium that can contain, store, or maintain the printer registrar for use by or in connection with the instruction execution system. The computer readable medium can include any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the device, system, and method of the present disclosure is embodied in software or code executed by general purpose hardware as discussed above, as an alternative the device, system, and method may also be embodied in dedicated hardware or a combination of software/general purpose hardware and dedicated hardware. If embodied in dedicated hardware, the device or system can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

It can be understood that all or part of the operations in the method of the above embodiments can be implemented by instructing related hardware via programs, the program may be stored in a computer readable storage medium, and the program includes one operation or combinations of the operations of the method when the program is executed.

In addition, each functional unit in the present disclosure may be integrated in one progressing module, or each functional unit exists as an independent unit, or two or more functional units may be integrated in one module. The integrated module can be embodied in hardware, or software. If the integrated module is embodied in software and sold or used as an independent product, it can be stored in the computer readable storage medium.

The computer readable storage medium may be, but is not limited to, read-only memories, magnetic disks, or optical disks.

Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

It should be noted that specific technical features described in the above-mentioned embodiments may be combined in any suitable way as long as no contradiction exists. In order to avoid unnecessary repetition, various possible combinations are not described in the present disclosure.

In addition, the embodiments of the present disclosure can be randomly combined without departing from the spirit of the present disclosure, and the combinations should be regarded as the contents disclosed in the present disclosure.

What is claimed is:

1. A method for determining a vehicle charging intention, comprising:
acquiring travel information of a target travel as target travel information;
determining a confidence level of a charging intention in the target travel according to the target travel information, wherein the confidence level of the charging intention is determined by a charging probability of at least one preset dimension, wherein the at least one preset dimension comprises a charging position dimension, a charging time dimension and a battery state dimension; and
determining whether the charging intention exists in the target travel according to the confidence level of the charging intention.

2. The method according to claim 1, wherein the target travel information comprises a target final position of the target travel, and determining the confidence level of the charging intention in the target travel according to the target travel information comprises:
determining a charging position matched with the target final position as a target charging position, wherein the charging position is a position where a vehicle is charged in a historical charging travel, and the historical charging travel is a travel in which the vehicle is charged;
determining the charging probability of the at least one preset dimension for the vehicle according to the target charging position and the target travel information; and
determining the confidence level of the charging intention according to the charging probability of the at least one preset dimension.

3. The method according to claim 2, wherein the target travel information further comprises a target starting position and a target driving route of the target travel; and when the at least one preset dimension comprises the charging position dimension, the charging probability of the charging position dimension for the vehicle is acquired by:
determining a probability of the vehicle being charged at the target charging position as a first probability;
determining a probability of the target final position being the charging position as a second probability; and
determining the charging probability of the charging position dimension for the vehicle according to a product of the first probability and the second probability.

4. The method according to claim 3, wherein determining the probability of the vehicle being charged at the target charging position as the first probability comprises:
acquiring a first number of times the vehicle is charged at the target charging position in the historical charging travels and a number of matching travels of which a final position is the target charging position in the historical charging travels; and
determining the first probability according to a ratio of the first number of times to the number of matching travels.

5. The method according to claim 3, wherein determining the probability of the target final position being the charging position as the second probability comprises:
determining a similarity between the target driving route and a driving route of a designated charging travel, wherein the designated charging travel is the historical charging travel of which a travel starting position matches the target starting position; and
determining the second probability according to the similarity corresponding to each designated charging travel.

6. The method according to claim 2, wherein the target travel information further comprises a target starting time point of the target travel, and when the at least one preset dimension comprises the charging time dimension, the charging probability of the charging time dimension is acquired by:
determining a charging starting time interval, in which the target starting time point is located, as a target time interval, wherein the charging starting time interval is preset according to a starting time point of every historical charging travel;
acquiring a second number of times the vehicle is charged in the target time interval in the historical charging travels and a first number of times the vehicle is charged at the target charging position in the historical charging travels; and
determining the charging probability of the charging time dimension for the vehicle according to a ratio of the second number of times to the first number of times.

7. The method according to claim 2, wherein the target travel information further comprises a target initial SOC value of a vehicle battery at a beginning of the target travel, and when the at least one preset dimension comprises the battery state dimension, the charging probability of the battery state dimension for the vehicle is acquired by:
determining an SOC range, in which the target initial SOC value is located, as a target SOC range, wherein the SOC range is preset according to an initial SOC value of every historical charging travel;
acquiring a third number of times the vehicle is charged in the target SOC range in the historical charging travels and a first number of times the vehicle is charged at the target charging position in the historical charging travels; and
determining the charging probability of the battery state dimension for the vehicle according to a ratio of the third number of times to the first number of times.

8. The method according to claim 2, wherein determining the confidence level of the charging intention according to the charging probability of the at least one preset dimension comprises:
determining the confidence level of the charging intention according to a product of the charging probability of the at least one preset dimension.

9. The method according to claim 1, wherein determining whether the charging intention exists in the target travel according to the confidence level of the charging intention comprises:
determining that the charging intention exists in the target travel when the confidence level of the charging intention is greater than or equal to a confidence threshold; and
determining that no charging intention exists in the target travel when the confidence level of the charging intention is less than the confidence threshold.

10. The method according to claim 1, wherein the target travel information comprises a target final position, a target starting time point, and a target initial SOC value of a vehicle battery at a beginning of the target travel, and before determining the confidence level of the charging intention in the target travel according to the target travel information, the method further comprises:
determining that the target travel information satisfies a preset condition comprising at least one of the following conditions:
among preset charging positions, at least one charging position being within a preset distance away from the target final position;
among preset charging starting time intervals, a charging starting time interval comprising the target starting time point existing; and
among preset SOC ranges, an SOC range comprising the target initial SOC value existing.

11. The method according to claim 1, wherein the target travel is determined by:
acquiring vehicle position information;
acquiring historical travel information of a vehicle, wherein the historical travel information comprises a historical starting time point, a historical initial SOC value, and a historical charging position of every historical charging travel, and further comprises a number of historical travels for each historical charging position of which a final position is the historical charging position and a number of times the vehicle is charged at each historical charging position;
generating a predicted travel according to the historical travel information and the vehicle position information; and
determining the target travel according to the predicted travel.

12. The method according to claim 11, wherein determining the target travel according to the predicted travel comprises:
outputting predicted travel information for characterizing the predicted travel; and
determining the predicted travel as the target travel when a confirmation instruction for the predicted travel information is received.

13. The method according to claim 1, wherein the target travel is determined by:
receiving a setting instruction for the target travel, wherein the setting instruction is used to indicate the travel information of the target travel; and
determining a travel indicated by the setting instruction as the target travel.

14. The method according to claim 1, further comprising:
when it is determined that the charging intention exists in the target travel, during driving process of a vehicle, controlling a battery temperature of the vehicle to be a target temperature, wherein the target temperature is a temperature suitable for charging a vehicle battery.

15. A device for determining a vehicle charging intention, comprising:
a processor;
a memory having stored therein a computer program that, when executed by the processor, causes the processor to perform a method for determining the vehicle charging intention, wherein the method comprises:
acquiring travel information of a target travel as target travel information;
determining a confidence level of a charging intention in the target travel according to the target travel information, wherein the confidence level of the charging intention is determined by a charging probability of at least one preset dimension, wherein the at least one preset dimension comprises a charging position dimension, a charging time dimension and a battery state dimension; and
determining whether the charging intention exists in the target travel according to the confidence level of the charging intention.

16. The device according to claim 15, wherein the target travel information comprises a target final position of the target travel, and determining the confidence level of the charging intention in the target travel according to the target travel information comprises:
determining a charging position matched with the target final position as a target charging position, wherein the charging position is a position where a vehicle is charged in a historical charging travel, and the historical charging travel is a travel in which the vehicle is charged;
determining the charging probability of the at least one preset dimension for the vehicle according to the target charging position and the target travel information; and
determining the confidence level of the charging intention according to the charging probability of the at least one preset dimension.

17. The device according to claim 16, wherein the target travel information further comprises a target starting position and a target driving route of the target travel, and when the at least one preset dimension comprises the charging position dimension, the charging probability of the charging position dimension for the vehicle is acquired by:
determining a probability of the vehicle being charged at the target charging position as a first probability;
determining a probability of the target final position being the charging position as a second probability; and
determining the charging probability of the charging position dimension for the vehicle according to a product of the first probability and the second probability.

18. The device according to claim 16, wherein the target travel information further comprises a target starting time point of the target travel, and when the at least one preset dimension comprises the charging time dimension, the charging probability of the charging time dimension is acquired by:
determining a charging starting time interval, in which the target starting time point is located, as a target time interval, wherein the charging starting time interval is preset according to a starting time point of every historical charging travel;
acquiring a second number of times the vehicle is charged in the target time interval in the historical charging travels and a first number of times the vehicle is charged at the target charging position in the historical charging travels; and
determining the charging probability of the charging time dimension for the vehicle according to a ratio of the second number of times to the first number of times.

19. The device according to claim 16, wherein the target travel information further comprises a target initial SOC value of a vehicle battery at a beginning of the target travel, and when the at least one preset dimension comprises the battery state dimension, the charging probability of the battery state dimension for the vehicle is acquired by:
determining an SOC range, in which the target initial SOC value is located, as a target SOC range, wherein the SOC range is preset according to an initial SOC value of every historical charging travel;
acquiring a third number of times the vehicle is charged in the target SOC range in the historical charging travels and a first number of times the vehicle is charged at the target charging position in the historical charging travels; and
determining the charging probability of the battery state dimension for the vehicle according to a ratio of the third number of times to the first number of times.

20. A vehicle for performing a method for determining a vehicle charging intention, the method comprising:
acquiring travel information of a target travel as target travel information;
determining a confidence level of a charging intention in the target travel according to the target travel information, wherein the confidence level of the charging intention is determined by a charging probability of at least one preset dimension, wherein the at least one preset dimension comprises a charging position dimension, a charging time dimension and a battery state dimension; and
determining whether the charging intention exists in the target travel according to the confidence level of the charging intention.
